(19) United States
(12) Patent Application Publication
(10) Pub. No.: US 2016/0356429 A1
(43) Pub. Date: Dec. 8, 2016

(54) LIGHT SOURCE MODULE AND OMNIDIRECTIONAL BULB LAMP

(71) Applicants: Cal-Comp Electronics & Communications Company Limited, New Taipei City (TW); Kinpo Electronics, Inc., New Taipei City (TW)

(72) Inventor: Chun-Min Wang, New Taipei City (TW)

(21) Appl. No.: 14/792,629

(22) Filed: Jul. 7, 2015

(30) Foreign Application Priority Data
Jun. 5, 2015 (TW) 104118310

(51) Int. Cl. F21K 99/00

(52) U.S. Cl. CPC F21K 9/135; F21K 9/50

(57) ABSTRACT

A light source module including a first reflector, a second reflector, plural supporting elements, and at least one light emitting element is provided. The first reflector has a first central portion and a first peripheral portion. The first peripheral portion has a curved surface facing the second reflector, and a thickness of the first peripheral portion gradually decreases outwards from the first central portion. The second reflector is disposed above the first reflector through the supporting elements and the second reflector has a second central portion and a second peripheral portion. The second central portion has a through hole. The second peripheral portion has an inclined surface facing the first reflector, and a thickness of the second peripheral portion gradually decreases outward from the second central portion. The light emitting element is disposed on the first central portion corresponding to the through hole. An omnidirectional lamp is also provided.

### CROSS-REFERENCE TO RELATED APPLICATION

This application claims the priority benefit of Taiwan application serial no. 104118310, filed on Jun. 5, 2015. The entirety of the above-mentioned patent application is hereby incorporated by reference herein and made a part of this specification.

### BACKGROUND OF THE INVENTION

Field of the Invention

The invention relates to a module and a bulb lamp, and particularly relates to a light source module and an omnidirectional bulb lamp.

Description of Related Art

Along with awareness of energy conservation and environmental protection, commercial products start to adopt devices and components with features of low power consumption, long service life and environmental protection, etc., so as to meet the demands on energy conservation and environmental protection. Taking an illumination technique as an example, a light emitting device (for example, a bulb lamp) generally adopts a light emitting element with features of low power consumption and environmental protection (for example, a light emitting diode (LED)) to serve as a light source. However, such type of the light emitting element has a high light directivity, so that the light emitting device is liable to be limited by a light emitting angle of the light emitting element, and cannot achieve a large angle light emission. After the Energy Star of America specifies a light shape specification of an omnidirectional bulb lamp, how to improve a light emitting range of the bulb lamp to cope with the light shape specification of the Energy star of America (for example, the light emitting range is within a section from 135 degrees to 180 degrees, and a light flux is not less than 5% of a total light flux) becomes one of the problems to be solved by related researchers.

### SUMMARY OF THE INVENTION

The invention is directed to a light source module, which has a large light emitting range.

The invention is directed an omnidirectional bulb lamp, which is complied with a light shape specification of the Energy Star of America.

The invention provides a light source module including a first reflector, a second reflector, a plurality of supporting elements and at least one light emitting element. The first reflector has a first central portion and a first peripheral portion surrounding the first central portion. The first peripheral portion has a curved surface facing the second reflector, and a thickness of the first peripheral portion is gradually decreased outwards from the first central portion. The second reflector is disposed opposite to the first reflector and has a second central portion and a second peripheral portion surrounding the second central portion. The second central portion has a through hole. The second peripheral portion has an inclined surface facing the first reflector, and a thickness of the second peripheral portion is gradually decreased outwards from the second central portion. The supporting elements are erected on the first reflector and support the second reflector. The at least one light emitting element is disposed on the first central portion corresponding to the through hole.

In an embodiment of the invention, the first reflector and the second reflector are respectively a white reflector.

In an embodiment of the invention, the through hole is located at a center of the second central portion and exposes the at least one light emitting element.

In an embodiment of the invention, the curved surface is a free-form curved surface.

In an embodiment of the invention, an included angle between the inclined surface and a surface of the second central portion facing the first reflector within the second reflector ranges between 70 degrees and 90 degrees.

In an embodiment of the invention, an included angle between a reference plane tangent to two opposite sides of the second peripheral portion and a bottom surface of the second peripheral portion ranges between 10 degrees and 30 degrees.

In an embodiment of the invention, each of the supporting elements is a columnar supporting element.

In an embodiment of the invention, the supporting elements are erected on the first peripheral portion of the first reflector and support the second peripheral portion of the second reflector.

In an embodiment of the invention, a diameter of the through hole is A, an outer diameter of the second reflector is B, and A/B is within a range of 7/40 to 9/38.

In an embodiment of the invention, a distance between the first central portion and the second central portion is C, and B/C is within a range of 11/40 to 14/38.

In an embodiment of the invention, the at least one light emitting element is a light emitting diode.

In an embodiment of the invention, the number of the at least one light emitting element is plural, and the light emitting elements are centrally arranged below the through hole.

In an embodiment of the invention, the light source module further includes a transparent lampshade. The transparent lampshade covers the first reflector, the second reflector, the supporting elements and the at least one light emitting element.

In an embodiment of the invention, a shape of the transparent lampshade is a hemisphere or a barrel.

The invention provides an omnidirectional bulb lamp including a lamp housing and a light source module disposed on the lamp housing. The light source module includes a first reflector, a second reflector, a plurality of supporting elements and at least one light emitting element. The first reflector has a first central portion and a first peripheral portion surrounding the first central portion. The first peripheral portion has a curved surface facing the second reflector, and a thickness of the first peripheral portion is gradually decreased outwards from the first central portion. The second reflector is disposed opposite to the first reflector and has a second central portion and a second peripheral portion surrounding the second central portion. The second central portion has a through hole. The second peripheral portion has an inclined surface facing the first reflector, and a thickness of the second peripheral portion is gradually decreased outwards from the second central portion. The supporting elements are erected on the first reflector and support the second reflector. The at least one light emitting element is disposed on the first central portion corresponding to the through hole.

In an embodiment of the invention, the first reflector and the second reflector are respectively a white reflector.

In an embodiment of the invention, the through hole is located at a center of the second central portion and exposes the at least one light emitting element.

In an embodiment of the invention, the curved surface is a free-form curved surface.

In an embodiment of the invention, an included angle between the inclined surface and a surface of the second central portion facing the first reflector within the second reflector ranges between 70 degrees and 90 degrees.

In an embodiment of the invention, an included angle between a reference plane tangent to two opposite sides of the second peripheral portion and a bottom surface of the second peripheral portion ranges between 10 degrees and 30 degrees.

In an embodiment of the invention, each of the supporting elements is a columnar supporting element.

In an embodiment of the invention, the supporting elements are erected on the first peripheral portion of the first reflector and support the second peripheral portion of the second reflector.

In an embodiment of the invention, a diameter of the through hole is A, an outer diameter of the second reflector is B, and A/B is within a range of 7/40 to 9/38.

In an embodiment of the invention, a distance between the first central portion and the second central portion is C and B/C is within a range of 11/40 to 14/38.

In an embodiment of the invention, the at least one light emitting element is a light emitting diode.

In an embodiment of the invention, the number of the at least one light emitting element is plural, and the light emitting elements are centrally arranged below the through hole.

In an embodiment of the invention, the light source module further includes a transparent lampshade. The transparent lampshade covers the first reflector, the second reflector, the supporting elements and the at least one light emitting element.

In an embodiment of the invention, a shape of the transparent lampshade is a hemisphere or a barrel.

In an embodiment of the invention, the bulb lamp further includes a lamp holder connected to the lamp housing.

According to the above descriptions, a light emitting range of the light source module is improved based on one or plural reflections of the first reflector and the second reflector, such that the omnidirectional bulb lamp applying the light source module is complied with the light shape specification of the Energy Star of America.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a cross-sectional view of a light source module according to an embodiment of the invention.

FIG. 1B and FIG. 1C are respectively a top view of a first reflector and a second reflector of FIG. 1A.

FIG. 2A to FIG. 2C are schematic diagrams illustrating light shapes of beams L1, L2, L3 in FIG. 1A.

FIG. 2D is a schematic diagram illustrating superposition of the light shapes of FIG. 2A to FIG. 2C.

FIG. 3 is an exploded view of an omnidirectional bulb lamp according to an embodiment of the invention.

### DESCRIPTION OF EMBODIMENTS

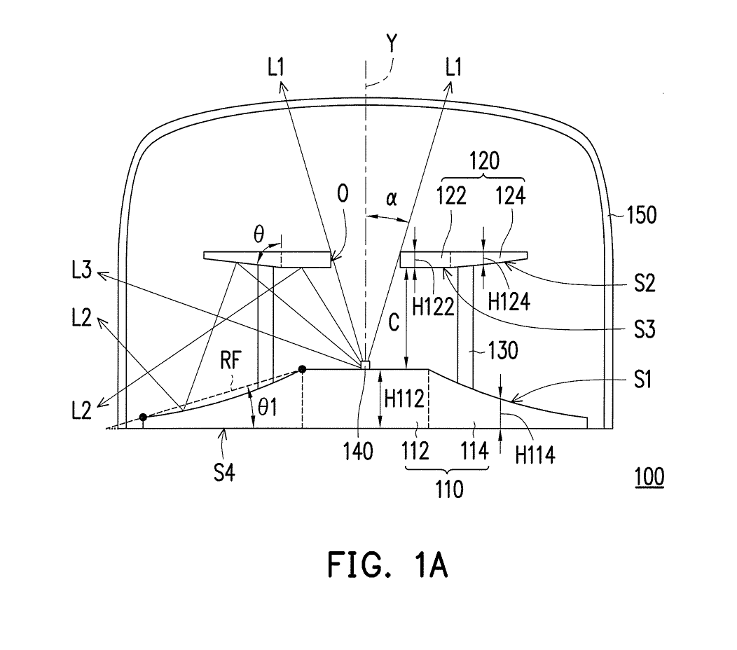

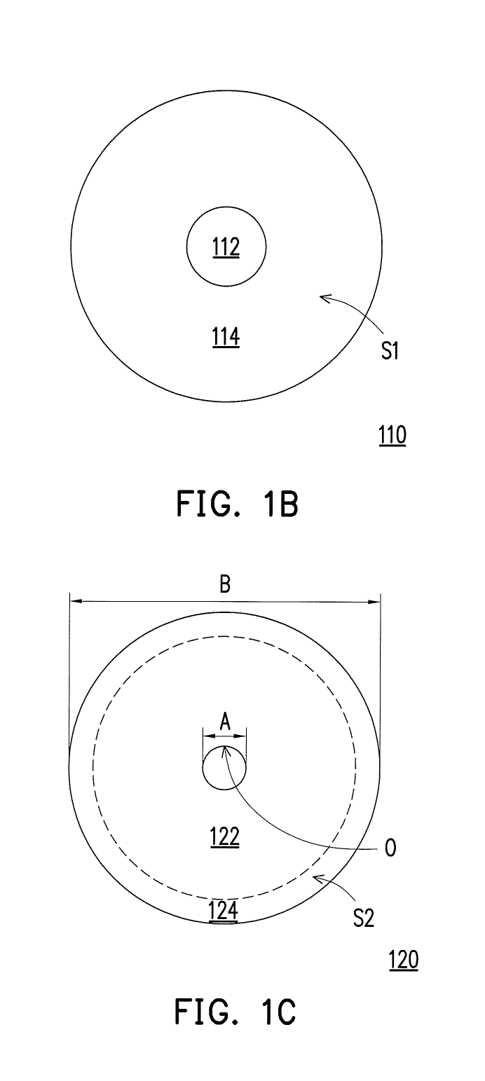

FIG. 1A is a cross-sectional view of a light source module according to an embodiment of the invention. FIG. 1B and FIG. 1C are respectively a top view of a first reflector and a second reflector of FIG. 1A. Referring to FIG. 1A to FIG. 1C, a light source module 100 includes a first reflector 110, a second reflector 120, a plurality of supporting elements 130 and at least one light emitting element 140.

The first reflector 110 has a first central portion 112 and a first peripheral portion 114 surrounding the first central portion 112. The first peripheral portion 114 has a curved surface S1 facing the second reflector 120, and a thickness H114 of the first peripheral portion 114 is gradually decreased outwards from the first central portion 112. As shown in FIG. 1A, a shape of the cross section of the first reflector 110 is similar to a trapezoid, wherein a thickness H112 of the first central portion 112 is a constant, and the thickness H114 of the first peripheral portion 114 at a boundary (shown by dashed lines) of the first central portion 112 and the first peripheral portion 114 is just equal to the thickness H112 of the first central portion 112.

The second reflector 120 is disposed opposite to the first reflector 110 and has a second central portion 122 and a second peripheral portion 124 surrounding the second central portion 122. The second central portion 122 has a through hole O. The through hole O penetrates through two opposite surfaces of the second central portion 122, and is, for example, located at a center of the second central portion 122. The second peripheral portion 124 has an inclined surface S2 facing the first reflector 110, and a thickness H124 of the second peripheral portion 124 is gradually decreased outwards from the second central portion 122. As shown in FIG. 1A, a shape of the cross section of the second reflector 120 is similar to a trapezoid, wherein a thickness H122 of the second central portion 122 is a constant, and the thickness H124 of the second peripheral portion 124 at a boundary (shown by dashed lines) of the second central portion 122 and the second peripheral portion 124 is just equal to the thickness H122 of the second central portion 122.

A material of the first reflector 110 and the second reflector 120 adopts a material with high reflectivity, and a reflection characteristic of the first reflector 110 and the second reflector 120 may include at least one of a mirror reflection and a diffused reflection. The material with high reflectivity is, for example, a material with a reflectivity greater than 90%, though the invention is not limited thereto. For example, the first reflector 110 and the second reflector 120 can be respectively a white reflector, though the invention is not limited thereto. In other embodiments, the first reflector 110 and the second reflector 120 can also be made of a transparent material, and a reflection layer (for example, a color paint) with high reflectivity is formed thereon.

The supporting elements 130 are erected on the first reflector 110 and support the second reflector 120. As shown in FIG. 1A, the supporting elements 130 are, for example, erected on the first peripheral portion 114 of the first reflector 110 and support the second peripheral portion 124 of the second reflector 120, wherein each of the supporting elements 130 is a columnar supporting element, and the number of the supporting elements 130 is, for example, two, though the configuration position, the pattern and the number of the supporting elements 130 are not limited to the aforementioned implementation. In an actual manufacturing process, the first reflector 110, the second reflector 120 and the supporting elements 130 can be formed integrally, or can be formed separately and then assembled together.

The light emitting element 140 is disposed on the first central portion 112 corresponding to the through hole O, and emits beams L1, L2, L3 (a difference between the beams L1, L2, L3 lies in emitting angles α thereof, wherein the emitting angle α is an included angle between a propagating direction of the beam and an optical axis Y) towards the second reflector 120. For example, the light emitting element 140 can be a light emitting diode.

Since the second reflector 120 is made of a material with high reflectivity, in order to avoid a situation that the second reflector 120 shields the beam L1 emitted from the light emitting element 140 in a small emitting angle, the light emitting element 140 is disposed below the through hole O and is exposed by the through hole O. The number of the light emitting elements 140 can be changed along with an actual design requirement, and is not limited to the implementation shown in FIG. 1A. When the number of the light emitting elements 140 is plural, the light emitting elements 140 can be centrally arranged below the through hole O.

Under the structure of the present embodiment, the beam L1 emitted from the light emitting element 140 in a small emitting angle can directly pass through the through hole O, and is output from a front part of the light source module 100. Moreover, the beam L3 emitted from the light emitting element 140 in a large emitting angle is directly output from a side part of the light emitting module 100 without being functioned (reflected) by the first reflector 110 or the second reflector 120. In addition, the beam L2 between the beam L1 and the beam L3 is reflected by at least one of the first reflector 110 and the second reflector 120 and is output from the side part and an oblique rear part of the light source module 100. In other words, by configuring the first reflector 110 and the second reflector 120, a light shape distribution of the light source module 100 can be modulated to improve a light emitting range.

By modulating a diameter A of the through hole O, a light output of the beam L1 output from the through hole O and a light emitting range of the beam L1 can be further controlled. Moreover, by modulating an outer diameter B of the second reflector 120 and a distance C between the first central portion 112 and the second central portion 122, a ratio between the beam L2 and the beam L3 is controlled. In addition, by modulating the curved surface S1 (for example, a curvature), and modulating at least one of an angle θ between the inclined surface S2 and a surface S3 of the second central portion 122 facing the first reflector 110 within the second reflector 120 and an angle θ1 between a reference plane RF tangent to two opposite sides (which are represented by two points in FIG. 1A) of the second peripheral portion 124 and a bottom surface S4 of the second peripheral portion 124, the light emitting range of the beam L2 can be controlled. In the present embodiment, a ratio between the diameter A and the outer diameter B (i.e., A/B) is within a range of 7/40 to 9/38, and a ratio between the outer diameter B and the distance C (i.e., B/C) is within a range of 11/40 to 14/38. Moreover, the curved surface S1 is a free-form curved surface. The angle θ ranges between 70 degrees and 90 degrees, and the angle θ1 ranges between 10 degrees and 30 degrees.

The light source module 100 may selectively include a transparent lampshade 150. The transparent lampshade 150 covers the first reflector 110, the second reflector 120, the supporting elements 130 and the light emitting element 140 for providing a suitable protection to the above elements. A shape of the transparent lampshade 150 can be a hemisphere or a barrel. The hemisphere is not limited to a half of a sphere. Moreover, a material of the transparent lampshade 150 adopts a material with high light transmittance to facilitate penetration of the beams L1, L2 and L3. It should be noted that, the material with high light transmittance is not limited to a material with 100% light transmittance. For example, the material of the transparent lampshade can be polycarbonate (PC), polymethyl methacrylate (PMMA) or glass, etc.

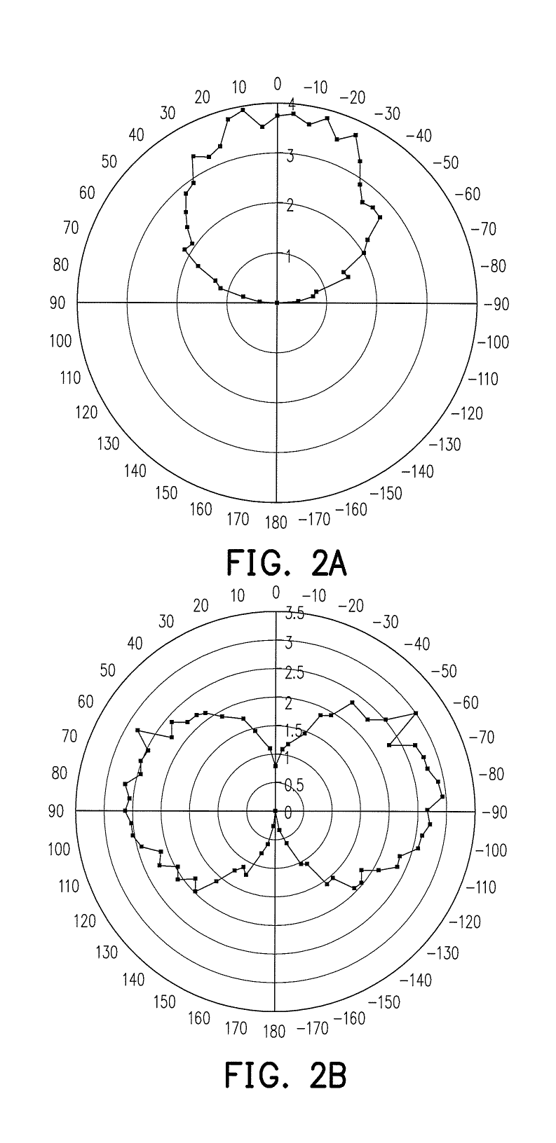

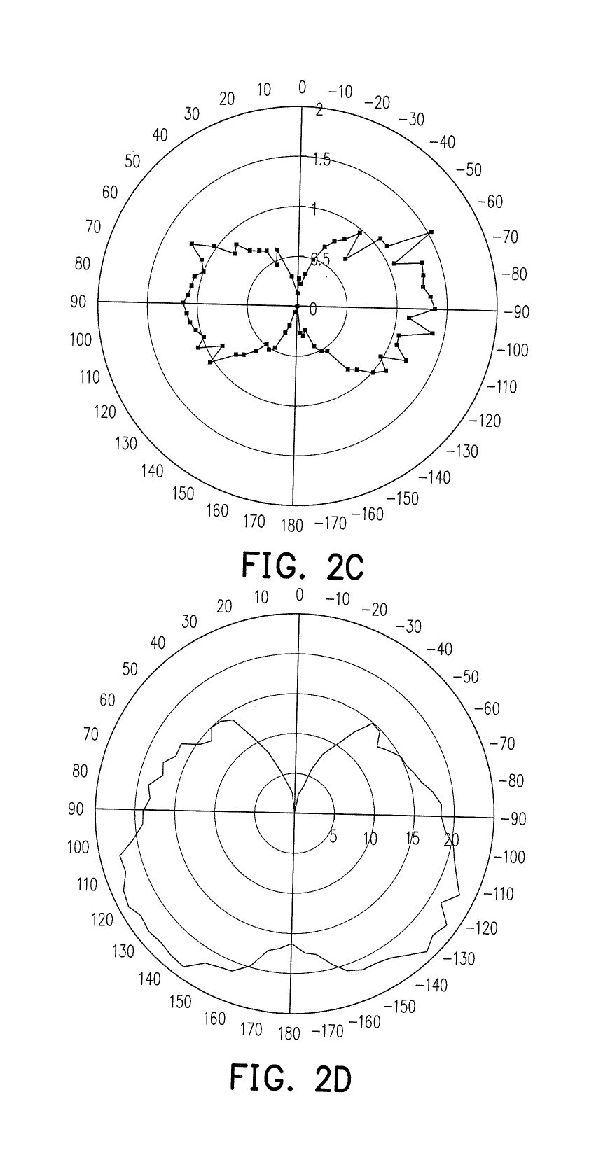

FIG. 2A to FIG. 2C are schematic diagrams illustrating light shapes of the beams L1, L2, L3 in FIG. 1A. FIG. 2D is a schematic diagram illustrating superposition of the light shapes of FIG. 2A to FIG. 2C. Referring to FIG. 2A to FIG. 2D, in case of the aforementioned design, an included angle between a propagating direction of the beam L1 emitted from the light source module 100 and the optical axis Y is mainly within a range between −60 degrees and 60 degrees, an included angle between a propagating direction of the beam L2 emitted from the light source module 100 and the optical axis Y is mainly within a range between 40 degrees and 130 degrees and within a range between −40 degrees and −130 degrees, and an included angle between a propagating direction of the beam L3 emitted from the light source module 100 and the optical axis Y is mainly within a range between 40 degrees and 110 degrees and within a range between −40 degrees and −110 degrees.

Generally, a light emitting range of the light emitting diode is approximately between −110 degrees and 110 degrees. In the present embodiment, as shown in FIG. 2D, the light emitting range of the light source module 100 is about between −160 degrees and 160 degrees. Therefore, by configuring the first reflector 110 and the second reflector 120, besides that the light shape distribution of the light source module 100 can be modulated, it also avails improving the light emitting range of the light source module 100.

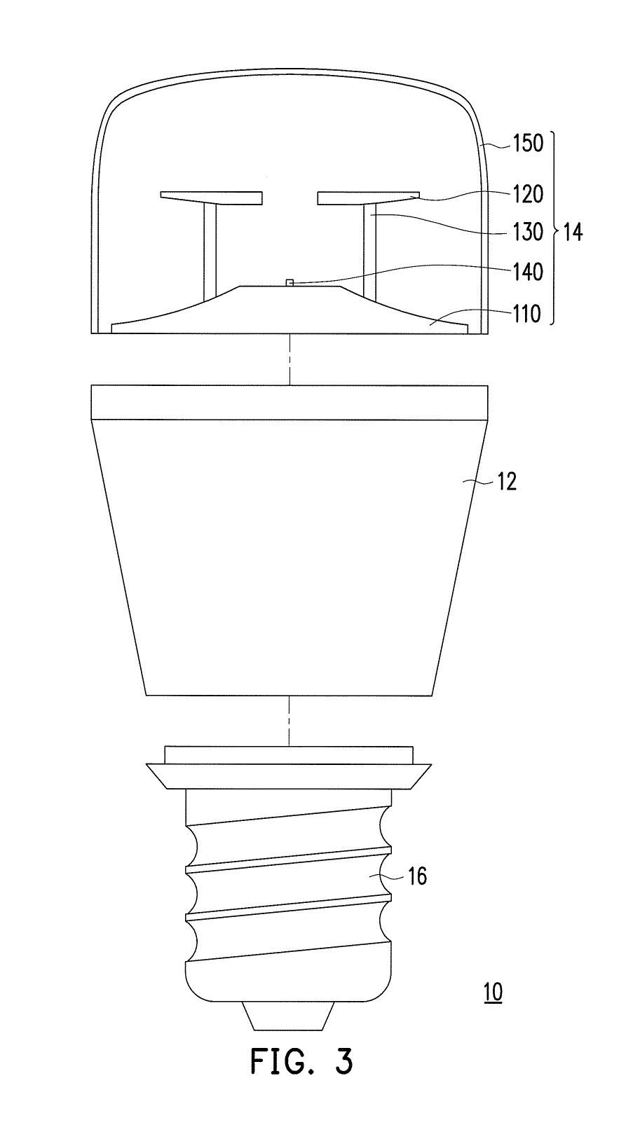

FIG. 3 is an exploded view of an omnidirectional bulb lamp according to an embodiment of the invention. Referring to FIG. 3, the omnidirectional bulb lamp 10 includes a lamp housing 12 and a light source module 14. The lamp housing 12 is, for example, heat dissipation lamp housing, and a material thereof can be aluminium or copper, etc. Moreover, the lamp housing 12 may have a plurality of cooling fins (not shown) for improving a heat dissipation effect.

The light source module 14 is disposed on the lamp housing 12, and the light source module 14 can be implemented by the light source module 100 of FIG. 1A to FIG. 1C. In this way, the light source module 14 may have a large light emitting range, such that the omnidirectional bulb lamp 10 applying the light source module 14 can be complied with the light shape specification of the Energy Star of America.

Moreover, the omnidirectional bulb lamp 10 may selectively include a lamp holder 16 connected to the lamp housing 12 for connecting an external power. A material of the lamp holder 16 can be a metal material, for example, copper, though the invention is not limited thereto.

In summary, in the embodiment of the invention, since a part of the beams emitted by the light emitting element can be propagated towards an oblique rear part of the light source module through one or plural reflections of the first reflector and the second reflector, the light emitting module may have a large light emitting range, such that the omnidirectional bulb lamp applying the light source module is complied with the light shape specification of the Energy Star of America.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A light source module, comprising:
a first reflector, having a first central portion and a first peripheral portion surrounding the first central portion, wherein a thickness of the first peripheral portion is gradually decreased outwards from the first central portion;
a second reflector, disposed opposite to the first reflector and having a second central portion and a second peripheral portion surrounding the second central portion, wherein the second central portion has a through hole, and a thickness of the second peripheral portion is gradually decreased outwards from the second central portion, wherein the first peripheral portion has a curved surface facing the second reflector, and the second peripheral portion has an inclined surface facing the first reflector;
a plurality of supporting elements, erected on the first reflector and supporting the second reflector; and
at least one light emitting element, disposed on the first central portion corresponding to the through hole.

2. The light source module as claimed in claim 1, wherein the first reflector and the second reflector are respectively a white reflector.

3. The light source module as claimed in claim 1, wherein the through hole is located at a center of the second central portion and exposes the at least one light emitting element.

4. The light source module as claimed in claim 1, wherein the curved surface is a free-form curved surface.

5. The light source module as claimed in claim 1, wherein an included angle between the inclined surface and a surface of the second central portion facing the first reflector within the second reflector ranges between 70 degrees and 90 degrees.

6. The light source module as claimed in claim 1, wherein an included angle between a reference plane tangent to two opposite sides of the second peripheral portion and a bottom surface of the second peripheral portion ranges between 10 degrees and 30 degrees.

7. The light source module as claimed in claim 1, wherein each of the supporting elements is a columnar supporting element.

8. The light source module as claimed in claim 1, wherein the supporting elements are erected on the first peripheral portion of the first reflector and support the second peripheral portion of the second reflector.

9. The light source module as claimed in claim 1, wherein a diameter of the through hole is A, an outer diameter of the second reflector is B, and A/B is within a range of 7/40 to 9/38.

10. The light source module as claimed in claim 9, wherein a distance between the first central portion and the second central portion is C, and B/C is within a range of 11/40 to 14/38.

11. The light source module as claimed in claim 1, wherein the at least one light emitting element is a light emitting diode.

12. The light source module as claimed in claim 1, wherein the number of the at least one light emitting element is plural, and the light emitting elements are centrally arranged below the through hole.

13. The light source module as claimed in claim 1, further comprising:
a transparent lampshade, covering the first reflector, the second reflector, the supporting elements and the at least one light emitting element.

14. The light source module as claimed in claim 13, wherein a shape of the transparent lampshade is a hemisphere or a barrel.

15. An omnidirectional bulb lamp, comprising:
a lamp housing; and
a light source module, disposed on the lamp housing, and comprising:
a first reflector, having a first central portion and a first peripheral portion surrounding the first central portion, wherein a thickness of the first peripheral portion is gradually decreased outwards from the first central portion;
a second reflector, disposed opposite to the first reflector and having a second central portion and a second peripheral portion surrounding the second central portion, wherein the second central portion has a through hole, and a thickness of the second peripheral portion is gradually decreased outwards from the second central portion, wherein the first peripheral portion has a curved surface facing the second reflector, and the second peripheral portion has an inclined surface facing the first reflector;
a plurality of supporting elements, erected on the first reflector and supporting the second reflector; and
at least one light emitting element, disposed on the first central portion corresponding to the through hole.

16. The omnidirectional bulb lamp as claimed in claim 15, wherein the first reflector and the second reflector are respectively a white reflector.

17. The omnidirectional bulb lamp as claimed in claim 15, wherein the through hole is located at a center of the second central portion and exposes the at least one light emitting element.

18. The omnidirectional bulb lamp as claimed in claim 15, wherein the curved surface is a free-form curved surface.

19. The omnidirectional bulb lamp as claimed in claim 15, wherein an included angle between the inclined surface and a surface of the second central portion facing the first reflector within the second reflector ranges between 70 degrees and 90 degrees.

20. The omnidirectional bulb lamp as claimed in claim 15, wherein an included angle between a reference plane tangent to two opposite sides of the second peripheral portion and a bottom surface of the second peripheral portion ranges between 10 degrees and 30 degrees.

21. The omnidirectional bulb lamp as claimed in claim 15, wherein each of the supporting elements is a columnar supporting element.

22. The omnidirectional bulb lamp as claimed in claim 15, wherein the supporting elements are erected on the first peripheral portion of the first reflector and support the second peripheral portion of the second reflector.

23. The omnidirectional bulb lamp as claimed in claim 15, wherein a diameter of the through hole is A, an outer diameter of the second reflector is B, and A/B is within a range of 7/40 to 9/38.

24. The omnidirectional bulb lamp as claimed in claim 23, wherein a distance between the first central portion and the second central portion is C, and B/C is within a range of 11/40 to 14/38.

25. The omnidirectional bulb lamp as claimed in claim 15, wherein the at least one light emitting element is a light emitting diode.

26. The omnidirectional bulb lamp as claimed in claim 15, wherein the number of the at least one light emitting element is plural, and the light emitting elements are centrally arranged below the through hole.

27. The omnidirectional bulb lamp as claimed in claim 15, wherein the light source module further comprises a transparent lampshade covering the first reflector, the second reflector, the supporting elements and the at least one light emitting element.

28. The omnidirectional bulb lamp as claimed in claim 27, wherein a shape of the transparent lampshade is a hemisphere or a barrel.

29. The omnidirectional bulb lamp as claimed in claim 15, further comprising:
a lamp holder, connected to the lamp housing.
